(19) United States
(12) Patent Application Publication
(10) Pub. No.: US 2007/0271177 A1
(43) Pub. Date: Nov. 22, 2007

(54) System and method for tracking mortgage information

(76) Inventors: Ben April, St. Louis, MO (US); James Blatt, St. Louis, MO (US)

Correspondence Address: RIEZMAN BERGER, P.C., 7700 BONHOMME AVENUE, 7TH FLOOR, ST. LOUIS, MO, 63105, US

(21) Appl. No.: 11/438,572

(22) Filed: May 22, 2006

(51) Int. Cl. G06Q 40/00

(52) U.S. Cl. 705/38

(57) ABSTRACT

A method for tracking mortgage information is disclosed which comprises the steps of obtaining information relating to a group of customers and a preselected criteria associated with the group of customers, obtaining updated information, comparing the updated information to the information relating to the group of customers and the preselected criteria to determine if a change has occurred, generating a list of customers from the group of customers of the change that has occurred, and sending a notification that a list has been generated. A system for tracking information related to a mortgage is also disclosed.

### BACKGROUND OF THE INVENTION

This invention relates to a system and method for tracking mortgage information and more particularly to a system and method for tagging or triggering information for generating reports for mortgage brokers or loan officers.

Mortgage companies have a database of customers that would benefit from information concerning a change in one or more underlying factors of a mortgage. For example, a customer would be interested in knowing whether a decline in interest rates would make refinancing an existing mortgage desirable or advantageous. However, in order to accomplish this task a loan officer would have to review each customer record and compare the record against interest rates that may change on a daily basis. As can be appreciated, this process is labor intensive and counterproductive. A loan officer would much rather spend time either developing new leads or servicing existing customers by closing loans or processing loans. Also, a loan officer may want to be able to compare different loan terms to an existing loan to determine if a customer should be contacted. However, once again, the loan officer would be forced to review each individual record and then compare the record against the updated information to determine if the customer or client should be contacted. This method is time consuming and may result in only a few of the customer accounts needing to be contacted after all of the records have been reviewed. There are times when a loan officer would like to know if the principal amount of a loan has decreased to a certain amount so that private mortgage insurance (PMI) would no longer be required. However, in order to accomplish this, a loan amortization schedule has to be prepared and reviewed. Again, this task is time consuming and may result wasted effort in that no customers may meet this criteria. As can be appreciated, there are several disadvantages associated with having a client database but no way to know when certain events occur.

Therefore, it would be desirable to have a system or method that is capable of interacting with a database to be able to locate information about the records within the database. For example, it would be advantageous to know when a customer would benefit from refinancing a loan based on various factors. Some of these factors may be a decrease in interest rates, a decrease in principal amounts, or an increase in monthly savings. Also, it would be desirable to be able to select one or more of these factors for generating a list of customers for a loan officer to contact. In particular, a customer may provide a loan officer with guidance that if the monthly payments could be reduced by a certain dollar amount even though the interest rate does not decrease by a certain amount then the customer should be contacted. However, there is no system or method that can provide this option.

### SUMMARY OF THE INVENTION

In one form of the present invention, a method for tracking mortgage information comprises the steps of obtaining information relating to a group of customers and a preselected criteria associated with the group of customers, obtaining updated information, comparing the updated information to the information relating to the group of customers and the preselected criteria to determine if a change has occurred, generating a list of customers from the group of customers of the change that has occurred, and sending a notification that a list has been generated.

In another form of the present invention, a system for tracking information related to a mortgage comprises a subscriber system for entering information relating to a customer and for selecting a portion of the information and a server system capable of accessing the information on the subscriber system, the server system for receiving updated information, for comparing the updated information to the selected portion of the information accessed from the subscriber system, and for generating a report to be sent to the subscriber system when the comparison indicates a change in the comparison.

In yet another form of the present invention, a system for tracking information related to a mortgage comprises a computer system capable of accessing information relating to a customer and a selection criterion associated with the customer, the computer system for receiving updated information, for comparing the updated information to the accessed information, and for generating a report when the comparison indicates a change in the comparison.

In light of the foregoing comments, it will be recognized that a principal object of the present invention is to provide a system and method for tracking mortgage information.

A further object of the present invention is to provide a system and method for tracking mortgage information that allows for the selection of various criteria to be tracked.

Another object of the present invention is to provide a system and method for tracking mortgage information that increases a loan officer's productivity.

A still further object of the present invention is to provide a system and method for tracking mortgage information that generates correspondence to a customer concerning any changes in a loan.

These and other objects and advantages of the present invention will become apparent after considering the following detailed specification in conjunction with the accompanying drawings, wherein:

### BRIEF DESCRIPTION OF THE DRAWINGS

FIG. 1 is a block diagram of a system for tracking mortgage information constructed according to the present invention;

FIG. 2 is a flow chart diagram illustrating a preferred operation of the method for tracking mortgage information according to the present invention;

FIG. 3 is an illustration of a screen which may be presented during use of the system for tracking mortgage information;

FIG. 4 is an illustration of a screen representative of a hotlist which may be presented during use of the system for tracking mortgage information;

FIG. 5 is an illustration of a screen representative of a disposition window which may be presented during the use of the system for tracking mortgage information;

FIG. 6 is an illustration of a screen representative of a status window which may be presented during the use of the system for tracking mortgage information;

FIG. 7 is an illustration of a screen representative of a follow up window which may be presented during the use of the system for tracking mortgage information;

FIG. 8 is an illustration of a screen representative of a send letter window which may be presented during the use of the system for tracking mortgage information;

FIG. 9 is an illustration of a screen representative of a hotlist settings window which may be presented during the use of the system for tracking mortgage information;

FIG. 10 is an illustration of a screen representative of icons which may be presented during the use of the system for tracking mortgage information;

FIG. 11 is an illustration of a screen representative of a customer search window which may be presented during the use of the system for tracking mortgage information;

FIG. 12 is an illustration of a screen representative of a generate a letter window which may be presented during the use of the system for tracking mortgage information;

FIG. 13 is an illustration of a screen representative of a mortgage calculator window which may be presented during the use of the system for tracking mortgage information; and

FIG. 14 is an illustration of a screen representative of a reports window which may be presented during the use of the system for tracking mortgage information.

### DETAILED DESCRIPTION OF THE PREFERRED EMBODIMENTS

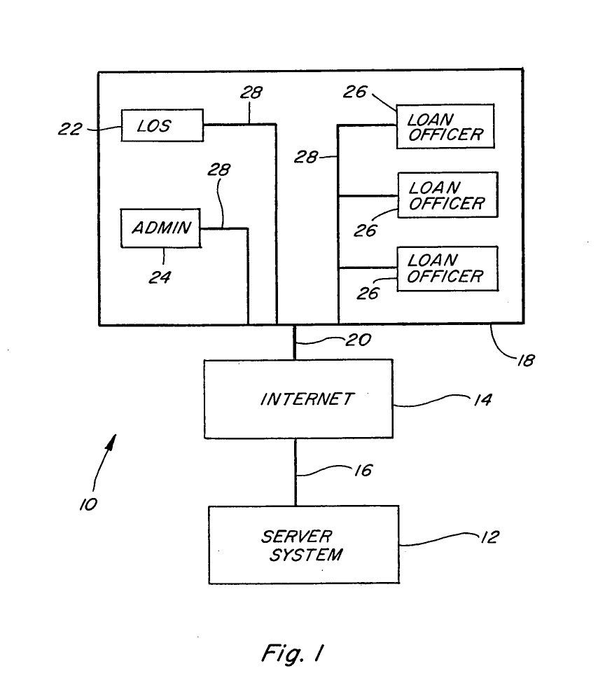

Referring now to the drawings, wherein like numbers refer to like items, number 10 identifies a system for tracking mortgage information according to the present invention. With reference now to FIG. 1, the system 10 is shown to comprise a server system 12 that is connected to a communications network such as the Internet 14 via a connection 16. The server system 12 may comprise a computer network that is capable of storing software programs and data. The server system 12 may comprise a single computer system or a number of computer systems grouped together. By way of example, the computer 12 may be a personal computer having a microprocessor, memory, a hard drive having stored thereon an operating system and other software, input devices such as a mouse, a CD-ROM drive, and a floppy disk drive. Other ancillary devices may be included such as a printer, a scanner, a modem, a router, or other network devices that allow the computer 12 to be connected to the Internet 14. The connection 16 may take on various forms such as a telephone line, cable, ISDN lines, fiber optic lines, wireless connections, microwave, radio, satellites, or other connection means.

A subscriber system 18 is also connected to the Internet 14 by a connection 20. The connection 20 may take on the same form or forms as the connection 16. The subscriber system 18 may be able to communicate with the server system 12 through the Internet connection 14 and the server system 12 may also communicate with the subscriber system 18 through the Internet 14. It is also possible that the connection between the server system 12 and the subscriber system 18 may be a direct and secure connection that bypasses the Internet 14. The subscriber system 18 subscribes to or contracts with the server system 12 to receive services from the system 12. The services may be in the form of web pages that are presented from the server system 12 to the subscriber system 18.

The subscriber system 18 is shown to comprise a loan origination system 22 that is capable of storing information related to loans that are being originated or administered. The information stored in the system 22 may include such data as names, addresses, loan date, loan amount, interest rate, loan term, property value, social security numbers, birthdates, and anniversary dates. This information is entered and captured when originating a loan, or when a loan is being refinanced, or at various other times during which a company is administering a loan. Also, this information is electronically stored and may be retrieved using various methods. The system 18 further comprises an administrator computer system 24 and loan officer computer systems 26. The loan origination system 22, the administration system 24, and the loan systems 26 may be connected via connections 28 to the connection 20 to the Internet 14. The connections 28 may be wired or wireless and may be part of a network of the system 18. Although not shown, the systems 24 and 26 may be connected to a printer or a network of printers. Further, the systems 22, 24, and 26 may take on various forms including a computer or a network of computers. The systems 22, 24, and 26, for example, may take on the same form as the system 12. The systems 22, 24, and 26 may be part of a network such as a local area network (LAN) or a wide area network (WAN).

Information or data stored on the loan origination system 22 may be retrieved or extracted by the server system 12. The retrieved or extracted information or data is integrated on the server system 12 after undergoing a series of normalization, standardization, and data upload processes. The data is regularly or periodically refreshed in order for the data to be current.

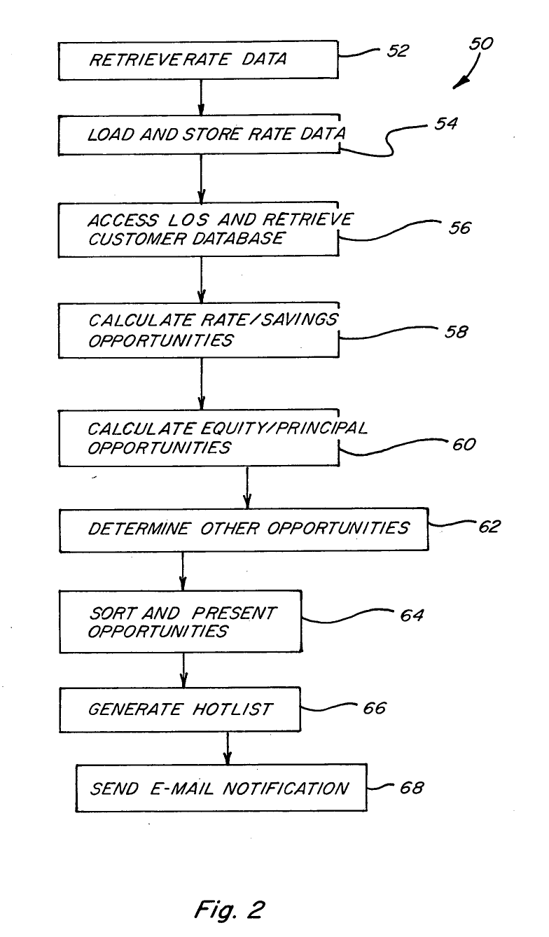

FIG. 2 is a flow chart diagram 50 of the general operation of the system 10. In an initial step 52, daily information or rate data is retrieved from various sources such as banks, savings and loans, credit unions, or mortgage bankers. This daily information may contain data such as interest rates, terms, types of loans, points, and other information relating to loans that a lender is willing to provide. This information is retrieved by the server system 12 over the Internet 14. It is also possible that this information may be manually inputted into the system 12. This information is then loaded and stored in the server system 12 in a next step 54. After the information is resident in the server system 12, in a next step 56 the server system 12 accesses the loan origination system 22 to retrieve customer database information. In a next step 58, individual accounts are accessed to calculate or determine if there are any rate or savings opportunities. For example, if the interest rates have decreased, then a calculation is made to determine is there will be any savings to a customer based upon the old interest rate of the loan and the interest rate for a new loan based on the daily rate information retrieved in the step 52. In a next step 60, a calculation is prepared that is representative of whether there is a principal or equity opportunity. In this step the server system 12 runs a full amortization schedule on every loan in the database and calculates increased equity or decreased principal opportunities. In particular, if the equity of the property has increased then there may be an opportunity to remove or cancel private mortgage insurance on the loan. After this calculation is completed, other information is reviewed in a step 62 to determine if other opportunities exist. For example, it may be beneficial to reduce the term of the loan, or it may be beneficial to refinance to an ARM, or the anniversary or birthday dates of the customer are approaching and the loan officer wants to know about these dates.

Once the calculations of steps 58, 60, and 62 have been completed, a step 64 is encountered where the opportunities are sorted and presented. In a next step 66, a loan officer hotlist is generated in which information for a particular loan officer having a listing of customers that have opportunities identified by the calculations of steps 58, 60, and 62 is prepared. As will be discussed further herein, a loan officer or an administrator can preselect what opportunities should be placed on the hotlist. Then in a step 68 an e-mail notification is sent to a loan officer to notify the loan officer that opportunities have been found or identified for the customers of the loan officer and the loan officer should log in to the server system 12.

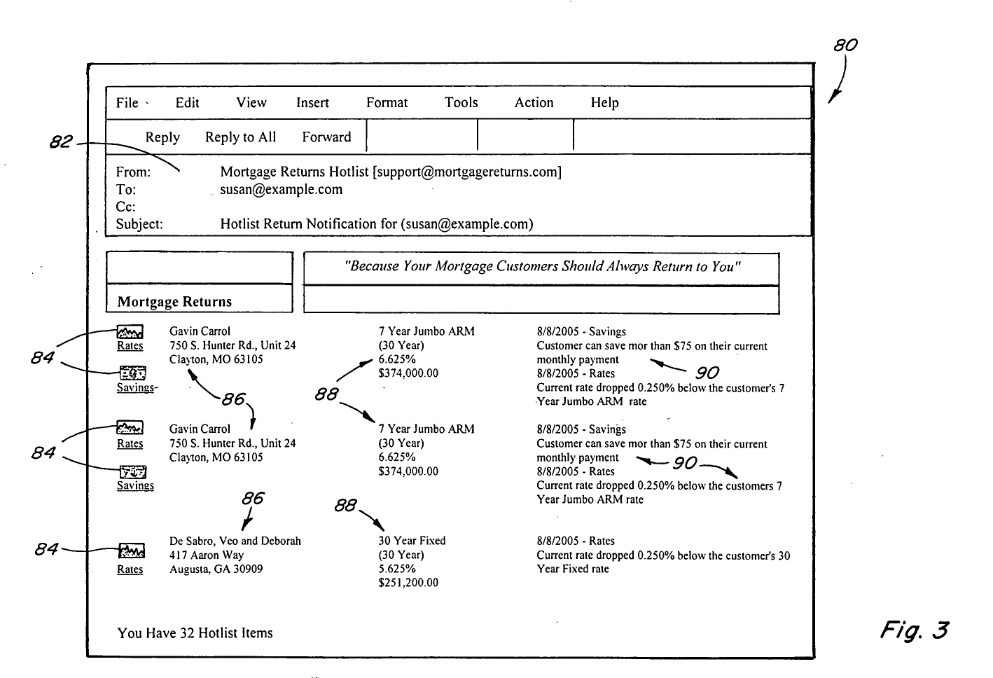

Referring now to FIG. 3, a screen 80 such as a video monitor associated with one of the loan officer computer systems 26 is depicted. The screen 80 has an e-mail notification 82 that is sent from the server system 12 to the subscriber system 18, as was discussed in step 68 of FIG. 2. The notification 82 can be sent on a periodic basis, such as daily, or whenever an event occurs that would require attention. The notification 82 includes links 84 that will directly connect the system 26 to a sign-on screen (not shown) associated with the server system 12. Once one of the links 84 is clicked by use of a mouse or other input device associated with the system 26, a log in screen will be shown on the screen 80. The log in screen will require that a user of the system 26 sign in by use of an e-mail address and a password. If for some reason the password is forgotten it is possible that personnel associated with the server system 12 or the subscriber system 18 are able to reset the particular password. The notification 82 also includes fields 86, 88, and 90 that contain information relating to the customer to be contacted in the field 86, information regarding current mortgage information in field 88, and information relating to a potential benefit to the customer or a reminder about a customer in field 90. The fields 86, 88, and 90 serve as a preview to alert the user that some action should be taken with respect to one or more customers. Further, the links 84 serve to indicate to the loan officer the reason that a customer should be contacted. For example, the interest rate for a loan has decreased by a certain amount that refinancing a loan would be advantageous to a customer.

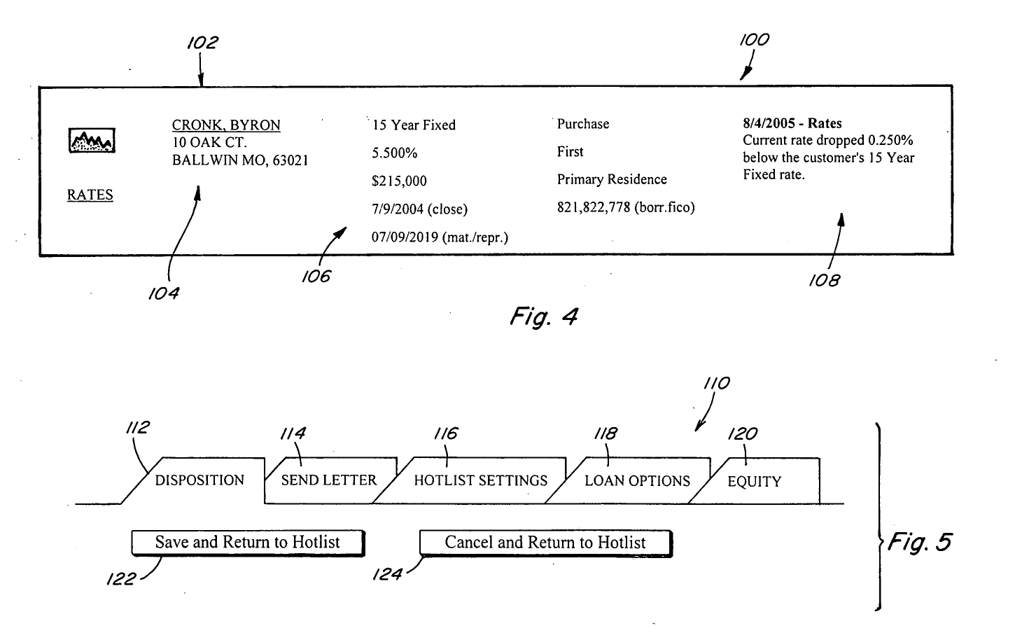

Once logged into the system 12 the loan officer will be presented with a hotlist screen 100 that is shown in FIG. 4. In this particular example only one customer is listed. However, more than one customer may be presented on the screen 100 or multiple screens depending on the number of customers that have been determined or identified by the system 12. The hotlist is a listing of customers that a loan officer should contact immediately and the reasons for the contact. Customers appear in the hotlist based on several factors such as market conditions which include current interest rates, new products, and changes in loan definitions, current principal or loan balance which include amortization and equity tracking to determine if a customer may qualify for conventional or other loan products or may be able to eliminate PMI, or calendar events which include specific loan events and annually recurring customer events. The screen 100 contains information relating to the customer such as customer name 102 and address 104. The customer name 102 is also a link that allows the loan officer to click this link to be taken to another screen (not shown) that includes further details about this particular customer. The screen 100 includes further information such as the current loan status of the customer 106 and one or more reasons 108 why the customer has been identified to be in the hotlist for the loan officer. The server system 12 is designed to present every record in the database on a hotlist at least twice each year. This will strengthen customer relationships by demonstrating active account management, generating increased loan activity by notifying customers of events or market conditions that may allow the customer to save money or meet other financial goals, and increase referrals.

The company administrator, by use of the computer system 24, can select company-wide default hotlist triggers. Each loan officer has the ability to modify these settings as will be discussed further herein. The triggers are used to generate a hotlist for the loan officer. For example, a trigger may be selected so that any customer of a particular loan officer will be placed on a hotlist whenever the interest rates decrease by half a percent. Some of the triggers that may be set or selected are noted as follows. A rate trigger may be set that compares the customer's interest rate to the interest rate currently available on the same type of loan. The trigger places the customer record on the hotlist when the current market rates on a specified loan type are a predetermined percentage below the customer's loan rate. A savings trigger may be selected that compares the customer's current principal and interest payment to the payment at current interest rates for the specific type of loan at its original balance. The trigger places the customer record on the hotlist when the payment would be a certain dollar amount below the customer's current payment. An equity trigger may be set that tracks the percentage of equity in a property based on the original appraised value and regular payments on the loan. This will indicate the ability to reduce or eliminate PMI payments or can track equity to determine when a borrower has sufficient equity to perform a major project or take cash out of the property. The trigger will place the customer on the hotlist when the equity percentage exceeds any of four threshold levels. A principal trigger may be set that compares the current loan principal based on regular payments on the loan. This information may be useful if the customer has lowered the remaining principal on the loan to qualify for a conforming loan rather than a Jumbo loan. The trigger fires when the remaining principal balance crosses a defined or selected threshold. A maturity trigger may be selected that indicates that it is time to contact the customer as their loan, such as a balloon note, is approaching maturity. This trigger will place the customer record on the hotlist when there are a certain selected number of days, weeks, months, or years remaining before the maturity date. A re-pricing trigger may be set that is indicative of it being time to contact a customer in advance of their adjustable rate loan re-pricing. For example, the trigger will fire when a certain number of days, weeks, months, or years remain before re-pricing. An anniversary trigger may be selected to indicate that it is time to contact a customer because their loan is reaching an anniversary date. This trigger can be set to place a customer record on the hotlist when a certain number of days, weeks, months, or years remain prior to the anniversary date. A birthday trigger can be set to signify an upcoming customer's birthday. The customer record will be put on the hotlist a certain number of days, weeks, months, or years prior to the birthday. All triggers can be activated or deactivated for a specific loan officer. Any adjustments to the triggers will only affect customers for the specific loan officer.

The loan officer may be taken to a disposition screen or window 110 which is shown in FIG. 5 by clicking anywhere in the screen 100. The disposition window 110 has a disposition tab 112, a send letter tab 114, a hotlist settings tab 116, a loan options tab 118, an equity tab 120, a save and return to hotlist tab 122, and a cancel and return to hotlist tab 124. All of the tabs 112, 114, 116, 118, 120, 122, and 124 may be selected by the loan officer to launch another screen or to return to the hotlist screen 100. The disposition window 110 is designed to help the loan officer determine what action is appropriate, communicate that action with the customer, customize future triggers or selection criteria for that individual customer's record, and note the disposition of the loan event into the comments section of the customer's record.

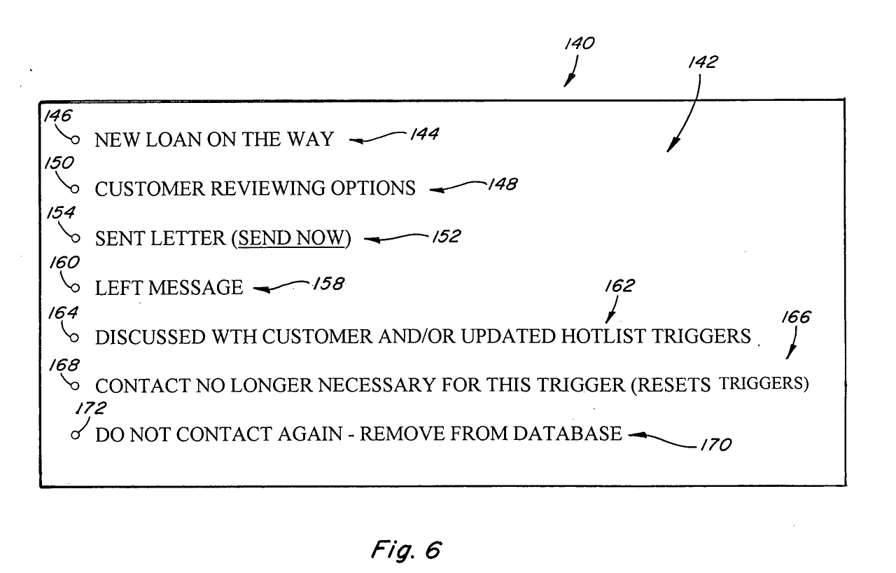

If the disposition tab 112 is selected another screen 140 is launched which includes the most common outcomes from the customer contact so that the type of contact can be tracked. The screen 140 is illustrated in FIG. 6. The screen 140 includes a listing 142 of the possible outcomes to be tracked. The first possible outcome in this listing 142 is identified as a new loan on the way 144. This outcome 144 also has a button 146 associated with it that a loan officer may click. If the customer has agreed to begin the origination process on a new loan or a refinance and an appointment has been scheduled then the loan officer will select the button 146. The second outcome or option 148 is listed as customer reviewing options. If the customer has decided to review the options presented by the loan officer then the officer will select a button 150 that is associated with this option 148. The third option 152 is indicated as being sent letter. This option 152 is used for noting whether a letter has been generated. This option also has a button 154 and a link 156. Selecting the link 156 will automatically direct the control of the system 12 to the send letter tab 114. Additional details concerning this tab 114 will be discussed more fully herein. The fourth option 158 is a left message option. This option 158 is for making a notation that the customer could not be reached. This option also has a button 160 associated with it for the loan officer to select. The next option 162 is delineated as a discussed with customer and/or updated hotlist triggers. This option 162 is used to note that the loan officer had a conversation with the customer or the hotlist triggers were updated and/or the loan officer changed some settings based on knowledge of the account or the customer. If this option is selected then the loan officer will select a button 164 associated with the option 162. The sixth option 166 concerns the situation where the contact is no longer necessary for this trigger. Selection of this option 166 is made by clicking a button 168 and this takes this item off the hotlist and resets all triggers. The last option 170 is for removing the customer from the database. Selection of a button 172 will accomplish this.

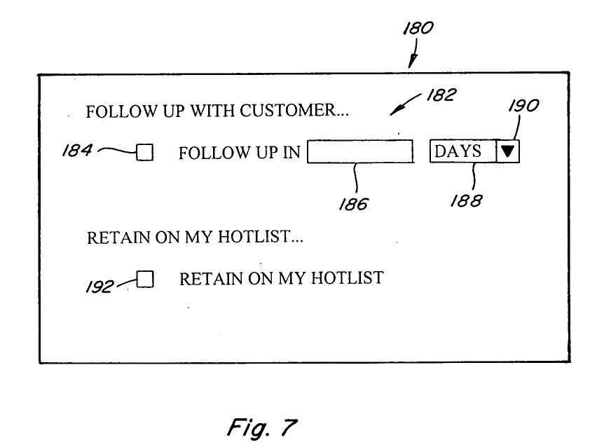

With reference now to FIG. 7, the loan officer is provided a screen 180 once one of the status buttons 146, 150, 154, 160, 164, 168, or 172 has been selected. The screen 180 is used for the loan officer to set a follow up trigger or retain the record on the hotlist for quick availability. In particular, the screen 180 includes an option 182 for selection by the loan officer. The option 182 is used to schedule the record to appear back on the hotlist after a specified period of time. For example, the option 182 includes a box 184 that can be selected to choose this option 182, a box 186 for entering therein a number, and a box 188 for selecting the time period such as days, months, or years. The box 188 includes an arrow 190 that may be selected by the loan officer to select the time period. The arrow 190 is clicked and a pull down menu (not shown) that includes various time options may be selected. The loan officer can also choose, regardless of the status selected, to retain the record on the hotlist by selecting a button 192. The button 192 corresponds to the option to retain the record on the hotlist. The screen 110 may include a box for entering information or notes. The entered information is automatically date-stamped and will remain with the customer record and may be sorted chronologically at the bottom of the screen 110. When the loan officer has completed entering information or selecting various options related to the screen 110, either the tab 122 or the tab 124 is clicked and the loan officer is returned to the hotlist screen 100.

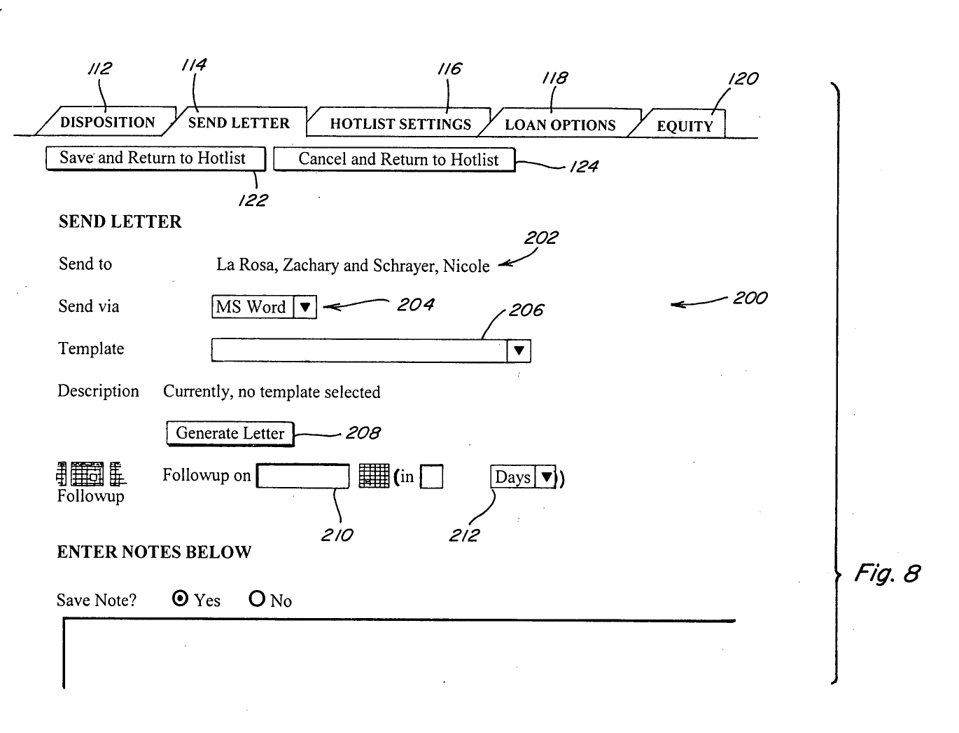

FIG. 8 shows a screen 200 that is launched when the loan officer selects the tab 114. The screen 200 is used to generate personalized letters to the customer listed in a box 202. The loan officer can select the method of sending correspondence by clicking on the box 204. Once the box 204 is selected, the loan officer is offered the availability of sending the correspondence via a word processing program such as MS word or by e-mail. Next, the loan officer may select a template for the correspondence by clicking on the box 206 which presents the available templates. For example, there may be prior templates saved by the loan officer that include information about a new loan having lower interest rates or a new loan having different terms. The screen 200 also has a box 208 that can be selected to create a new template. The date and a description of the letter sent are automatically noted in the customer's record. If the correspondence is being sent via a word processing program then a window will be launched prompting the loan officer to open a document. Once a document is opened, the name and address of the customer are merged into the document and the document may be printed out to be sent or mailed to the customer. Correspondence or letters can be saved locally on the computer 26 of the loan officer. A follow up trigger is presented in boxes 210 and 212 by allowing the loan officer to either select the month and day or the number of days that should elapse before the record appears on the hotlist. Clicking the tab 122 will complete the letter generation process and the customer record will be removed from the hotlist.

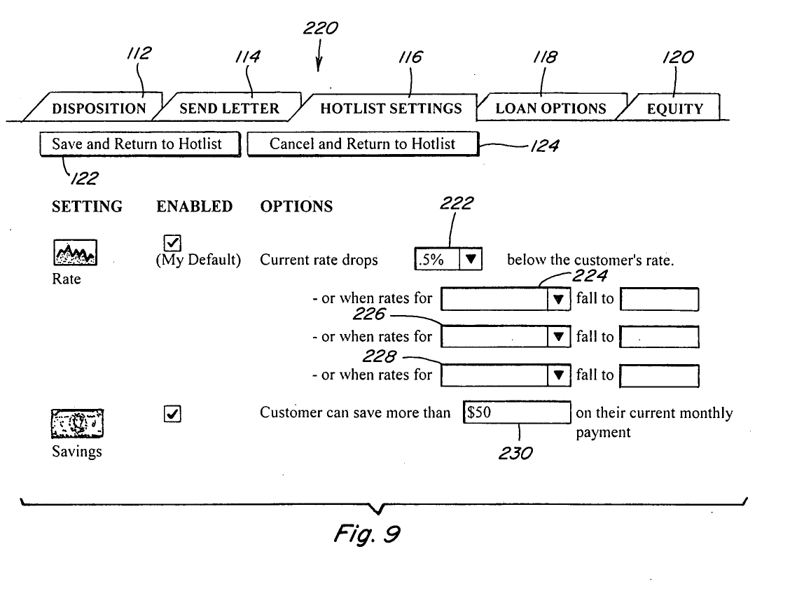

If the loan officer selects the tab 116 then a screen 220, as illustrated in FIG. 9, is launched. The screen 220 allows the loan officer to set or customize hotlist triggers on a customer-by-customer basis. The loan officer can set various hotlist triggers with respect to a change in the interest rates. In particular, the loan officer can select by the use of a box 222 the change in the rate for which a customer will be put on the hotlist. By clicking on the box 222, a pull down menu is opened having various amounts that can be selected. There are additionally three boxes 224, 226, and 228 that may be selected by the loan officer to track other rates for the customer. A savings trigger box 230 is also provided in which the loan officer may insert a dollar amount. For example, if a new loan would result in a savings of $50 per month then this event would place the customer on the hotlist. Once the hotlist settings have been entered, the loan officer may select the tab 122.

In addition to the boxes 222, 224, 226, 228, and 230 shown in FIG. 9, there are other hotlist settings that may be selected. The equity in the property may be tracked so that when the percentage of equity reaches a certain point the hotlist will indicate the ability to reduce or eliminate PMI. The equity may also be tracked to determine if a major home project may be started. The principal on the current loan may be computed based on regular payments on the loan. When a customer has lowered the remaining principal to qualify for a conforming, rather than a Jumbo loan, this event would place the customer on the hotlist to be notified. The trigger may be set when the remaining principal balance crosses a defined threshold. The maturity date of the loan is an event that the loan officer may want to know. For example, the loan officer may want to set a trigger to place the customer on the hotlist when the loan will mature within a year. In this event the loan officer is able to contact the customer to determine if the customer wants to take out another loan. The trigger for maturity may be set a predefined number of days, weeks, months, or years in advance. If the customer has an adjustable rate mortgage then the loan officer may want to contact the customer prior to the adjustment date of the loan. Again, the trigger for the adjustment or repricing of the loan may be set a predefined number of days, weeks, months, or years in advance. The anniversary date of the closing of the loan may be another time period in which a loan officer would want to contact a customer. The loan officer may want to contact the customer to determine if there are any other financial instruments, such as a second mortgage, that the customer may want to have information. The trigger may be set based upon the number of days, weeks, months, or years before the anniversary. Also, the loan officer may want to contact the customer on the customer's birthday or other life event. The option of setting this trigger may be based on the number of days, weeks, months, or years before the birthday or event.

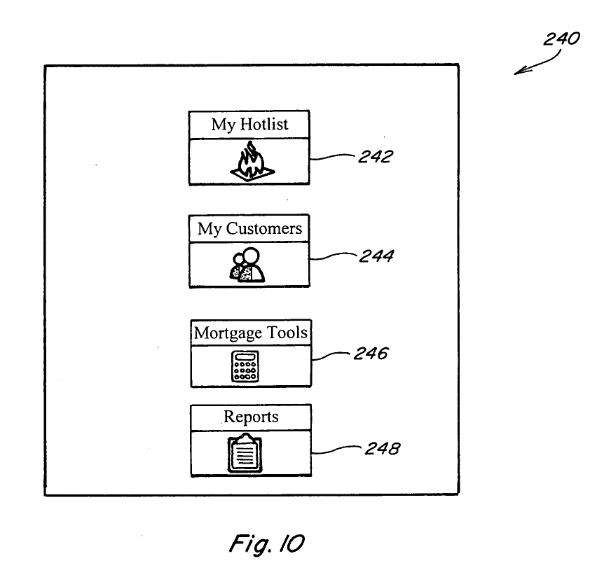

Once logged into the server system 12 the loan officer or the administrator using one of the computer systems 26 may also control or manipulate data or information representative of the customers of the particular loan officer or the loan officer can maneuver around a software program associated with the server system 12. For example a web page or a screen 240 as shown in FIG. 10 may be displayed on the monitor of the computer system 26. The screen 240 includes four icons 242, 244, 246, and 248 that can be selected or clicked by the loan officer. The icon 242 is to review the hotlist for the loan officer. If the loan officer selects the icon 242 then the screen 100 will be launched for the loan officer to navigate the hotlist. The icon 244 may be selected to allow the loan officer to review the complete database of all customers associated with the loan officer. The icon 246 is used to operate a mortgage calculator. Finally, the icon 248 may be selected to generate various reports. The icons 242, 244, 246, and 248 may be used throughout the program or software that is presented to the loan officer. Further, each of the icons 242, 244, 246, and 248 has a particular color associated with it and the color themes are used throughout the site or program to distinguish each section.

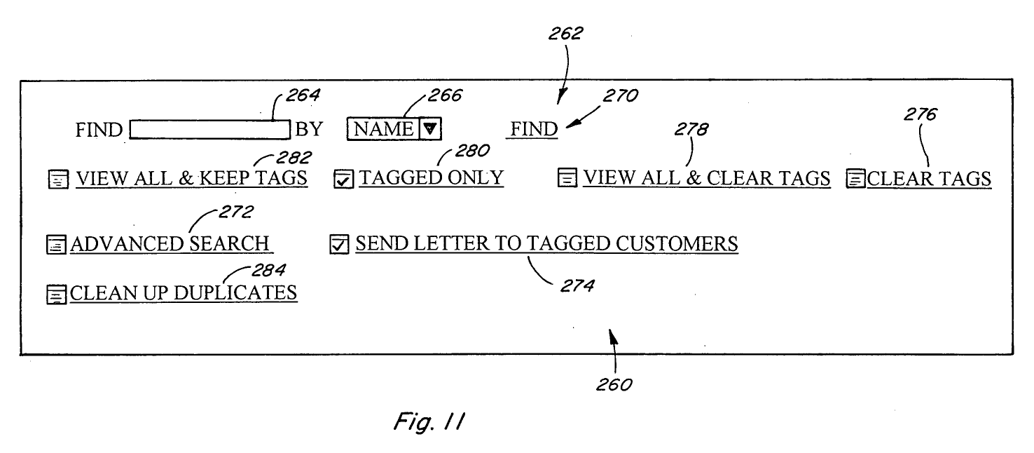

FIG. 11 depicts a screen or web page 260 that is provided to the loan officer if the loan officer selects icon 244 on the screen 240. The web page 260 allows the loan officer to view a listing of the loan officer's customers. By default the data is listed alphabetically by the customer's last name. The database can be easily sorted. The screen 260 provides a quick find option 262 that allows for fast retrieval of a particular customer record by name, address, or loan number. In order to quickly find a customer the loan officer types in a name, address, or loan number in a box 264, specifies which field should be searched by selecting the appropriate field in a box 266 by use of a pull down menu, and then clicks on a find link 270. A customer record may include data such as the customer name, address, contact information for the borrower and co-borrower, loan details, payment details, credit scores, internal information, employment information, history of previous loans, hotlist triggers, contact history, notes, disposition details, all related parties in the transaction such as real estate agents or brokers, appraisers, send letter options which is the same as the mail merge function found on the hotlist disposition screen 110, mortgage company defined fields, and status of all triggers for that particular customer record.

To find a specific subset of customers from among the entire group of customers listed under the icon 244, there are some powerful advanced search capabilities that may be employed by selecting a link 272. Clicking on the advanced search link 272 takes the loan officer to another screen (not shown) that allows the loan officer to fill out the desired search criteria. For example, a search of the customer database may be made that includes the various criteria of looking for loans at a certain dollar amount, looking for certain loan programs, looking for loans at certain rates, and looking for loans with HELOCs that may be able to refinance to one loan.

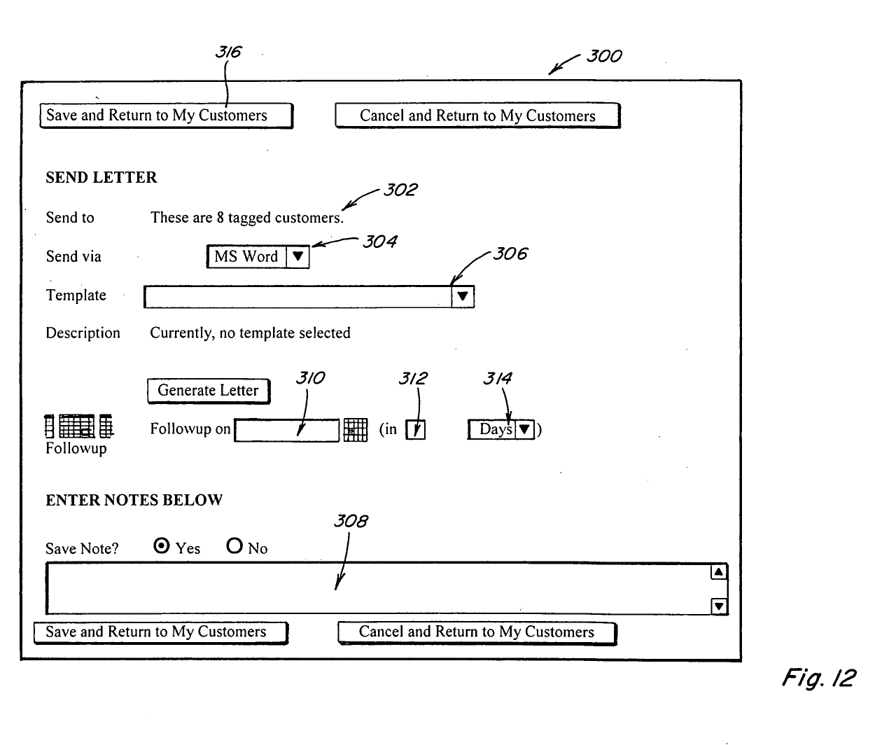

Another option available on the screen 260 is the ability to send letters to a group of customers. This is accomplished by selecting the link 274. Once this link 274 is chosen a new screen or web page 300, as shown in FIG. 12, is launched. The screen 300 includes an identification 302 of the number of customers that have been tagged to receive a letter. In this particular example there are eight tagged customers that will be sent a letter concerning their loan. The loan officer is required to select a method of how the letters will be sent by opening up a drop down menu 304. When the menu 304 is opened two options that are available are a word processing program or e-mail. The loan officer may also choose a template for the correspondence by selecting a template from a drop down box 306. If the letters are to be sent by use of a word processing program then a window will open prompting the loan officer to open a document. The title of the letter sent will beautomatically captured along with the date and time the letter is generated. Additional descriptions may be entered in a note field 308. Follow up triggers may be set by entering information in a box 310 such as a calendar date or a number may be entered in a box 312. The number entered in the box 312 may be modified by a pull down menu 314 which the loan officer may select days, week, months, or years. Once the date or a number is entered for the follow up trigger the record will appear on the hotlist of the loan officer to determine if the customer has responded to the correspondence. After all the information is entered, the loan officer may click a save and return button 316 to complete the activity for this screen 300.

Referring back to FIG. 11, the list of tagged customers can be refined by untagging one or more customers from the list. A clear tag link 276 may be selected by the loan officer. To reset the screen 260 a view all and clear tags link 278 may be pressed. After all of the records that are desired to be untagged are untagged, a tagged only link 280 may be clicked to display on the tagged records. Also, the loan officer can select a view all and keep tags link 282 to view a listing of the customers that have been tagged. An option is provided to clean up any duplicate records within the customer database. A clean up duplicates link 284 is provided on the screen 260. A duplicate loan is a record where some combination of name and address match.

Notes and comments between the loan officer and the customer can be logged into the system 12. The icon 244 may be selected to open the screen 260. The find option 264 is used to open the customer's record. A customer's record screen (not shown) is launched and there is a link provided that is identified as log contact. If the log contact link is selected then a box is opened that allows the loan officer to enter information about a conversation between the loan officer and the customer. If the details of the log entry require a follow up with the customer, a follow up trigger can be set so that the record appears on the hotlist of the loan officer on a specific date. Further, if the details of the conversation require an adjustment to the hotlist triggers, updates can be made directly from a hotlist tab provided within the customer detail record screen.

With reference now to FIG. 13, if the icon 246 is selected then the loan officer is taken to a new screen or web page 340 that provides the loan officer with the ability to compare customers' account details to a variety of potential loan scenarios. The screen 340 includes two icons 342 and 344 that when selected will launch new screens. The icon 342 is used to open a calculator that allows the loan officer to estimate the total equity a customer has invested in their home. The equity figure is based on configurable annual appreciation rates along with regular monthly payments. The results are expressed in both equity percentage and total dollar amount and can be displayed based on annual, semi-annual, quarterly, and monthly results. The icon 344 can be selected to open a calculator that allows the loan officer to compare a customer's current loan details to three other loan scenarios. Monthly payments, total interest over the life of the loan and the differences of each compared to the customer's current loan details may be presented. Each of the calculators will automatically present the loan details from the selected customer record. By selecting the icon 246 for mortgage tools, without having to first select a customer record, the loan officer can enter in any loan details into the calculators to discuss the results with prospects or with current customers.

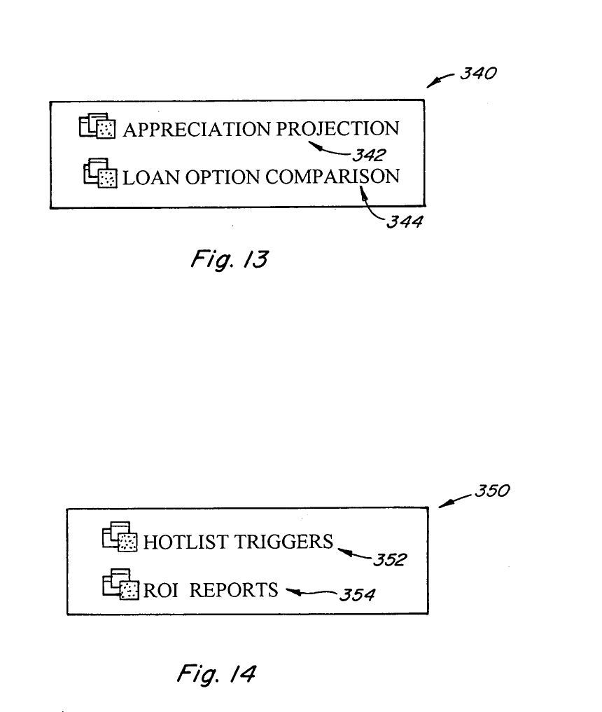

If the icon 248 is selected then the loan officer will be taken to a new screen or web page 350, as shown in FIG. 14, where various report options are available. The screen 350 includes an icon 352 that is used for viewing various activity reports and an icon 354 that is used to view various return on investment reports. The icon 352 allows the loan officer to view summary reports sorted by hotlist trigger, summary reports showing both the hotlist trigger and disposition information, or detail reports showing hotlist triggers and their corresponding dispositions on a customer-by-customer basis. The icon 354 allows the loan officer to view summary reports showing the total number of new loans closed that were previously presented on the hotlist and detail reports showing the same information on a customer-by-customer basis. The reports generated by clicking the icon 354 allow the loan officer or the administrator to see how much increased revenue is generated by the use of the server system 12.

From all that has been said, it will be clear that there has thus been shown and described herein a system and method for tracking mortgage information which fulfills the various objects and advantages sought therefore. It will become apparent to those skilled in the art, however, that many changes, modifications, variations, and other uses and applications of the subject system and method for tracking mortgage information are possible and contemplated. All changes, modifications, variations, and other uses and applications which do not depart from the spirit and scope of the invention are deemed to be covered by the invention, which is limited only by the claims which follow.

What is claimed is:

1. A method for tracking mortgage information comprising the steps of:
obtaining information relating to a group of customers and a preselected criteria associated with the group of customers;
obtaining updated information;
comparing the updated information to the information relating to the group of customers and the preselected criteria to determine if a change has occurred;
generating a list of customers from the group of customers of the change that has occurred; and
sending a notification that a list has been generated.

2. The method of claim 1 further comprising the step of generating correspondence for one of the customers from the list of customers.

3. The method of claim 1 further comprising the step of generating correspondence for all of the customers from the list of customers.

4. The method of claim 1 wherein the preselected criteria is an interest rate.

5. The method of claim 1 wherein the preselected criteria is a principal.

6. The method of claim 1 wherein the preselected criteria is an anniversary date.

7. A system for tracking information related to a mortgage comprising:
a subscriber system for entering information relating to a customer and for selecting a portion of the information; and
a server system capable of accessing the information on the subscriber system, the server system for receiving updated information, for comparing the updated information to the selected portion of the information accessed from the subscriber system, and for generating a report to be sent to the subscriber system when the comparison indicates a change in the comparison.

8. The system of claim 7 wherein the selected portion of information is an interest rate.

9. The system of claim 7 wherein the selected portion of information is a principal amount.

10. The system of claim 7 wherein the selected portion of information is a savings amount.

11. The system of claim 7 wherein the subscriber system can retain a customer on the report.

12. The system of claim 7 wherein the generated report is sent to the subscriber system by e-mail.

13. The system of claim 7 wherein the subscriber system further comprises a loan officer computer system, an administrator computer system, and a loan origination system.

14. A system for tracking information related to a mortgage comprising a computer system capable of accessing information relating to a customer and a selection criterion associated with the customer, the computer system for receiving updated information, for comparing the updated information to the accessed information, and for generating a report when the comparison indicates a change in the comparison.

15. The system of claim 14 further comprising a subscriber system that is capable of connecting to the computer system.

16. The system of claim 14 wherein the selection criterion is an interest rate.

17. The system of claim 14 wherein the selection criterion is a principal amount.

18. The system of claim 14 wherein the selection criterion is a savings amount.

19. The system of claim 14 wherein the selection criterion is a date.

20. The system of claim 14 further comprising a subscriber system comprising a loan officer computer system, an administration computer system, and a loan origination system.
